(19) United States
(12) Patent Application Publication
(10) Pub. No.: US 2010/0220951 A1
(43) Pub. Date: Sep. 2, 2010

(54) ROLLER BEARING

(75) Inventors: Joerg Spielfeld, Schweinfurt (DE); Stefan Glueck, Niederwerrn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/913,512

(22) PCT Filed: Apr. 28, 2006
(86) PCT No.: PCT/DE2006/000741

§ 371 Date: Dec. 13, 2007

(30) Foreign Application Priority Data
May 4, 2005 (DE) 10 2005 020 783.9

(51) Int. Cl. F16C 33/46

(52) U.S. Cl. 384/572

(57) ABSTRACT

The invention relates to a roller bearing, with an inner running ring, an outer running ring, several roller bodies arranged between the running rings and guided in a bearing cage, whereby the bearing cage has axially aligned cage pins evenly distributed around the circumference, each fixed at one end to a cage ring on each of which a roller body is arranged to rotate on a central bearing drilling. According to the invention, the operating properties of the roller bearing may be improved, whereby the roller cage is provided at each cage pin with at least one passive positioning element, by means of which the offset of the corresponding roller body may be altered by means of a temperature-dependent change of shape of the positioning element.

### FIELD OF THE INVENTION

The invention relates to a roller bearing, having an inner raceway, an outer raceway, a plurality of rolling bodies which are arranged between the raceways and are guided in a bearing cage, in which roller bearing the bearing cage for holding the rolling bodies has axially aligned cage journals which are arranged so as to be distributed uniformly in the peripheral direction and which are each fastened at one side to a cage ring and on which one rolling body each is rotatably mounted with a central bearing bore.

### BACKGROUND OF THE INVENTION

A roller bearing is composed, in a simple embodiment, of two raceways, the inner raceway and the outer raceway, as well as the rolling bodies and the bearing cage. In the event of a relative rotation of the inner raceway with respect to the outer raceway, the rolling bodies roll on the tracks of the raceways. The rolling movement of the rolling bodies is composed of a rolling movement and a sliding movement on the tracks of the raceways, with the rolling movement being predominant and ensuring a very much lower friction resistance than a pure sliding movement.

By means of the bearing cage, the rolling bodies are guided between the raceways so as to be distributed uniformly about the periphery and spaced apart from one another, resulting in uniform loading of the bearing components over the periphery, true and smooth running, low wear and a high service life and a low rotational resistance of the roller bearing.

In geometrically larger roller bearings, the bearing cage is often embodied as a so-called journal cage and then has predominantly axially aligned cage journals for mounting and guiding the rolling bodies. In this way, in contrast to bearing cages which are provided with rolling body pockets, axial webs between the rolling bodies are avoided, so that the peripheral spacing of the rolling bodies to one another can be reduced and, for otherwise identical dimensions, altogether more rolling bodies can be arranged distributed over the periphery.

In contrast to other designs, a roller bearing having a journal cage has, for identical outer dimensions, a higher load-bearing capacity and a more precise guidance of the rolling bodies. One possible embodiment of a roller bearing of said type is for example described in DE 100 31 427 C2. In said embodiment, the cage journals are fastened in two cage rings which are arranged axially to the side of the roller bearings, which does result in a high stability of the bearing cage, but is disadvantageously associated with a large axial width of the roller bearing.

In another possible embodiment of a roller bearing of said type, the cage journals are fastened at one side to a cage ring, and the rolling bodies are each secured with thin-walled end caps which are fastened at the end side on the cage journals, which end caps can be formed individually or can be combined in a common annular end cap. Alternatively, the axial securing of the rolling bodies can likewise take place by means of an annular guide web which is arranged on one of the raceways. Double-row roller bearings which are provided with a journal cage can be of particularly compact design by virtue of the cage journal of both bearing rows being fastened to a common, centrally arranged cage ring.

Roller bearings having largely freely projecting cage journals have the disadvantage, however, that the cage journals can, at high load, bend in the peripheral direction counter to the rotational direction, which leads to a misalignment, referred to as offset, of the rolling bodies, which misalignment results in an increased bearing resistance and intensified wear of the bearing components in question. It is therefore necessary to suppress, compensate or, in order to adapt to certain mechanical and thermal loads, targetedly set the load-dependent offset of the roller bearings.

### OBJECT OF THE INVENTION

The invention is therefore based on the object of refining a roller bearing of the type specified in the introduction in as simple and cost-effective manner as possible with regard to improved operating properties.

### SUMMARY OF THE INVENTION

The invention is based on the realization that, by arranging temperature-dependently-acting passive actuating elements on the cage journals of the bearing cage, an automatic load-dependent variation or setting of the offset of the rolling bodies and therefore an adaptation of the roller bearing to the present load is possible. For the passive control of the actuating elements, it is possible to utilize the fact that the operating temperature of the roller bearing increases on account of friction with increasing load. In addition, it is also possible to actively influence the setting of the offset of the relevant roller bearing by arranging a heating or cooling element in the vicinity of the installation location of a roller bearing.

The invention therefore concerns, according to the features of the main claim, a roller bearing, having an inner raceway, an outer raceway, a plurality of rolling bodies which are arranged between the raceways and are guided in a bearing cage, in which roller bearing the bearing cage for holding the rolling bodies has axially aligned cage journals which are arranged so as to be distributed uniformly in the peripheral direction and which are each fastened at one side to a cage ring and on which one rolling body each is rotatably mounted with a central bearing bore. It is additionally provided that the bearing cage is provided at each of the cage journals with at least one passive actuating element, by means of which an offset of the associated rolling body as a result of a temperature-dependent shape change of the actuating element can be varied.

Advantageous embodiments of the roller bearing according to the invention are the subject matter of claims 2 to 8.

By arranging the passive actuating elements on the cage journals of the bearing cage, the offset of the rolling bodies can be increased, reduced or held constant with increasing loading, which is associated with a rising temperature, without an external control action, and as a function of the specific application and the desired operative interaction, by means of a corresponding design and geometrical arrangement of the actuating elements.

By means of a corresponding design of said actuating elements, the temperature-dependent shape change can consist of an expansion of the actuating element, a bending of the actuating element or a combination of these.

As a material for the actuating elements, use is preferably made of a shape-memory alloy, for example a nickel-titanium alloy, of which the actuating elements are at least partially composed depending on the design.

Shape-memory alloys, while having high mechanical and thermal load capacity, have considerably greater shape changes such as expansion and bending than known materials for passive actuating elements such as bimetal. The shape changes of the shape-memory alloys are brought about by internal structure conversion between martensite and austenite, which occur in a relatively small temperature range. Shape-memory alloys are therefore particularly suitable for use in passive actuating elements in applications with temperature-dependent functions. Applications in thermostat valves of engine cooling systems and in fan couplings of brake systems of motor vehicles are for example already known.

Likewise known, for example from JP 06200933 A, JP 63009720 A and JP 01060243 A are components composed of shape-memory alloys for temperature-dependent influencing of the axial or radial installation play of roller bearings. Particularly suitable for applications of said type are nickel-titanium alloys since their structure conversion takes place in the temperature range from −35° C. to +85° C., which is encountered frequently in practical operational use. Nickel-titanium alloys also have good damping properties which, in an application in roller bearings, improve the running smoothness of the latter.

In a first embodiment of the roller bearing according to the invention, the cage journals are fastened rigidly in the cage ring, and the associated actuating element is embodied as a peripherally-acting bending joint which is arranged outside the cage ring between the journal foot and the journal shank of the relevant cage journal. The offset of the rolling bodies is therefore set directly by means of a temperature-dependent pivoting of the cage journals by means of the actuating elements, with it being necessary for said actuating elements, on account of the force transmission between the journal shanks and the journal feet of the cage journal, to be dimensioned to be of corresponding strength.

In a second embodiment of a roller bearing according to the invention, the cage journals are fastened in the cage ring so as to be pivotable to a limited extent in the peripheral direction in each case about a ring-side radial joint axis, and in that the associated actuating element is embodied as a support web which is arranged at least on one side outside the cage ring so as to be angled in the peripheral direction between the cage ring and the journal foot of the relevant cage journal. In this connection, the cage journals are pivoted in the peripheral direction by means of a temperature-dependent expansion and/or bending of the associated actuating elements and a resulting reduction or increase in the effective length of the actuating elements. In order that this is possible, even in the case of an arrangement of actuating elements on the cage journals at both sides, without mutual interference, the actuating elements are, in this case, expediently designed and arranged so as to act asymmetrically with respect to the longitudinal axis of the associated cage journal, that is to say have in each case an opposing or different expansion, and/or a bending in the same peripheral direction, as a function of the temperature.

In a third embodiment of a roller bearing according to the invention, the cage journals are likewise fastened in the cage ring so as to be pivotable to a limited extent in the peripheral direction about a ring-side radial joint axis. The respective actuating element is however now embodied as an expansion element which is arranged within the cage ring with largely peripheral alignment, spaced apart from the joint axis, and in operative contact with the journal foot of the relevant cage journal. The action of the actuating elements is the same in this design as in the previously described embodiment. As a result of the arrangement of the actuating elements within the bearing ring, however, the axial width of the roller bearing is advantageously reduced.

### BRIEF DESCRIPTION OF THE DRAWINGS

The invention is explained in more detail below on the basis of the appended drawings of some exemplary embodiments. Here, in the drawings:

FIG. 1 shows a first embodiment of the roller bearing according to the invention on the basis of a section of a cylinder roller bearing,

FIG. 2 shows a second embodiment on the basis of a section of a cylinder roller bearing;

FIG. 3 shows a third embodiment on the basis of a section of a spherical roller bearing.

### DETAILED DESCRIPTION OF THE DRAWINGS

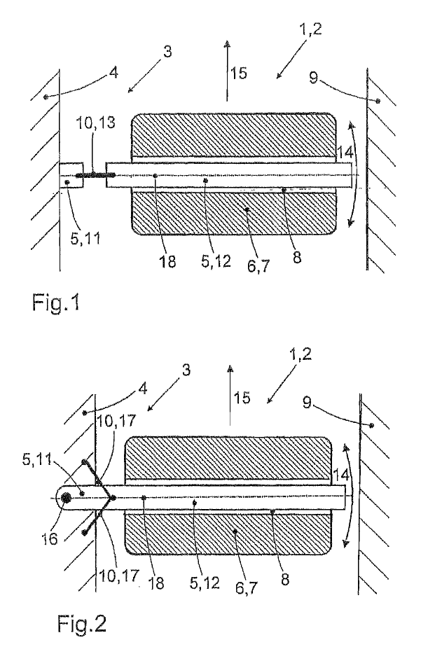

A roller bearing 1 which is depicted in section in FIG. 1 and is embodied as a cylinder roller bearing 2 has a bearing cage 3 with a cage ring 4 on which a plurality of axially aligned cage journals 5 which are arranged so as to be distributed uniformly in the peripheral direction are arranged. The cage journals 5 are each fastened at one side to the cage ring 4. A rolling body 6 which is embodied as a cylinder roller 7 is rotatably mounted with a central bearing bore 8 on each of the cage journals 5.

The end-side securing of the rolling bodies 6 is ensured by means of an annular guide web 9 of one of the raceways. In the present case, the cage journals 5 are in each case rigidly fastened in the cage ring 4 and have a temperature-sensitive passive actuating element 10 which is preferably composed at least partially of a shape-memory alloy such as for example a nickel-titanium alloy, and can therefore in principle perform a temperature-dependent shape change, that is to say an expansion and/or a bending. In the present case, the respective actuating element 10 is arranged outside the cage ring 4 between the journal foot 11 and the journal shank 12 of the relevant cage journal 5 and is embodied as a peripherally acting bending joint 13.

A temperature-dependent pivoting of the actuating element 10 results in an automatic rotation 14 of the cage journal 5 in the rotational direction 15 or counter to the rotational direction 15 of the roller bearing 1 and therefore a corresponding offset of the rolling bodies 6. This can be utilized to set a desired offset of the rolling bodies 6 or to compensate an undesired offset caused by the mechanical loading of the roller bearing 1. Since the loading forces of the cage journal 5 are transmitted entirely via the actuating element 10 into the cage ring 4, the actuating element 10 is dimensioned to be of corresponding strength.

In a roller bearing 1 which is depicted in section in FIG. 2 and is likewise embodied as a cylinder roller bearing 2, the cage journals 5 are each fastened in the cage ring 4 so as to be pivotable to a limited extent in the peripheral direction about a ring-side radial joint axis 16. Two temperature-sensitive passive actuating elements 10 which are embodied as support webs 17 are arranged on the cage journals 5, which actuating elements 10 are fastened outside the cage ring 4 so as to be angled in the peripheral direction between the cage ring 4 and the journal foot 11 of the relevant cage journal 5.

In said arrangement, the cage journals 5 are, by means of a temperature-dependent expansion and/or bending of the associated actuating elements 10, pivoted in the rotational direction 15 or counter to the rotational direction 15 of the roller bearing 1, and the offset of the relevant rolling body 6 is thereby varied.

Since the two support webs 17 which are arranged on a cage journal 5 would act in opposite directions with respect to the pivoting movement in the case of a symmetric design and arrangement, a design and/or arrangement of the actuating elements 10 which is asymmetric with respect to the longitudinal axis 18 of the associated cage journal 5 is necessary in this case. The two support webs 17 therefore have in each case an opposing or different expansion, and/or a bending in the same peripheral direction, as a function of the temperature.

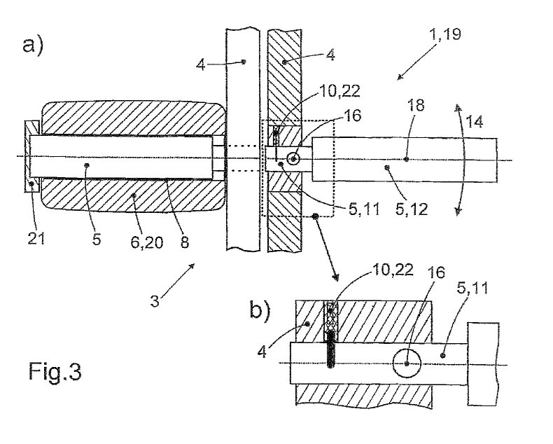

In a further embodiment which is illustrated in FIG. 3 in a radial view in an enlarged section in sub-FIG. 3a and in an enlarged partial section from sub-FIG. 3a in sub-FIG. 3b, a roller bearing 1 which is embodied as a double-row spherical roller bearing 19 has two adjacent cage rings 4 on which a plurality of cage journals 5 are arranged so as to be distributed uniformly in the peripheral direction.

In each case one rolling body 6 which is embodied as a spherical roller 20 is rotatably mounted with a central bearing bore 8 on the cage journals 5 and secured at the end side by means of an end cap 21. The cage journals 5 are fastened with their journal foot 11 in the cage ring 4 so as to be pivotable to a limited extent in the peripheral direction about a ring-side radial joint axis 16. A temperature-sensitive passive actuating element 10 which acts substantially as an expansion element 22 is arranged within the respective cage ring 4 with peripheral alignment, spaced apart from the joint axis 16, and in operative contact with the journal foot 11 of the cage journal 5. The action of the actuating elements 10 is the same in this design as in the previously described embodiment. As a result of the arrangement of the actuating elements 10 within the bearing ring 4, however, the axial width of the roller bearing 1 is advantageously reduced.

### LIST OF REFERENCE SYMBOLS

1 Roller bearing
2 Cylinder roller bearing
3 Bearing cage
4 Cage ring
5 Cage journal
6 Rolling bodies
7 Cylinder roller
8 Bearing bore
9 Guide web
10 (Passive) actuating element
11 Journal foot
12 Journal shank
13 Bending joint
14 Rotation
15 Rotational direction
16 Joint axis
17 Support web
18 Longitudinal axis
19 Spherical roller bearing
20 Spherical roller
21 End cap
22 Expansion element

1. A roller bearing comprising: an inner raceway, an outer raceway, a plurality of rolling bodies which are arranged between the raceways and are guided in a bearing cage, in which roller bearing the bearing cage for holding the rolling bodies has axially aligned cage journals which are arranged so as to be distributed uniformly in the peripheral direction and which are each fastened at one side to a cage ring and on which one rolling body each is rotatably mounted with a central bearing bore, with the bearing cage being provided at each of the cage journals with at least one passive actuating element, by means of which an offset of the associated rolling body as a result of a temperature-dependent shape change of the actuating element can be varied.

2. The roller bearing as claimed in claim 1, wherein the temperature-dependent shape change consists of an expansion and/or a bending of the actuating element.

3. The roller bearing as claimed in claim 1, wherein the actuating element is composed at least partially of a shape-memory alloy.

4. The roller bearing as claimed in claim 3, wherein the shape-memory alloy of the actuating element (10) is embodied as a nickel-titanium alloy.

5. The roller bearing as claimed in claim 1, wherein the cage journals are fastened rigidly in the cage ring and in that the associated actuating element is embodied as a peripherally-acting bending joint which is arranged outside the cage ring between the journal foot and the journal shank of the relevant cage journal.

6. The roller bearing as claimed in claim 1, wherein the cage journals are fastened in the cage ring so as to be pivotable to a limited extent in the peripheral direction about a ring-side radial joint axis, and in that the in each case associated actuating element is embodied as a support web which is arranged at least at one side outside the cage ring so as to be angled in the peripheral direction between the cage ring and the journal foot of the relevant cage journal.

7. The roller bearing as claimed in claim 6, wherein the actuating elements, in the case of an arrangement at both sides on the cage journal, are each designed and/or arranged so as to act asymmetrically with respect to the longitudinal axis of the associated cage journal.

8. The roller bearing as claimed in claim 1, wherein the cage journals are fastened in the cage ring so as to be pivotable to a limited extent in the peripheral direction about a ring-side radial joint axis, and in that the associated actuating element is embodied as an expansion element which is arranged within the cage ring with largely peripheral alignment, spaced apart from the joint axis and in operative contact with the journal foot of the relevant cage journal.
